(19) United States
(12) Patent Application Publication
(10) Pub. No.: US 2026/0265978 A1
(43) Pub. Date: Sep. 10, 2026

(54) CONDUCTIVITY SENSOR FOR A WASHING MACHINE APPLIANCE

(71) Applicant: Haier US Appliance Solutions, Inc., Wilmington, DE (US)

(72) Inventors: Erick Flores Islas, Louisville, KY (US); Todd Anthony Reger, Crestwood, KY (US); Otto Armando Ramirez, Louisville, KY (US)

(21) Appl. No.: 19/070,702

(22) Filed: Mar. 5, 2025

(51) Int. Cl. D06F 34/22; B29C 45/14; B29L 31/00; D06F 23/04; D06F 39/02; D06F 103/20; G01N 21/59; G01N 27/06

(52) U.S. Cl. CPC D06F 34/22; B29C 45/14065; D06F 23/04; D06F 39/02; G01N 21/59; G01N 27/06; B29C 2045/14131; B29L 2031/762; D06F 2103/20

(57) ABSTRACT

A system and method for assembling a washing machine appliance, the washing machine appliance including a wash tub positioned within a cabinet, a wash basket rotatably mounted within the wash tub, a dispensing assembly for selectively adding wash fluid to the wash tub, a sump positioned proximate to a bottom of the wash tub for collecting wash fluid, and a sensor assembly positioned within the cabinet. The sensor assembly includes a sensor including a plurality of sensor rods (e.g., a conductivity sensor), wherein the plurality of sensor rods includes a keyed feature, and a sensor housing overmolded onto the sensor.

### FIELD OF THE INVENTION

The present subject matter relates generally to washing machine appliances, or more specifically, to the conductivity sensors within a washing machine appliance.

### BACKGROUND OF THE INVENTION

Washing machine appliances generally include a tub for containing water or wash fluid, e.g., water and detergent, bleach, and/or other wash additives. A basket is rotatably mounted within the tub and defines a wash chamber for receipt of articles for washing. During normal operation of such washing machine appliances, the wash fluid is directed into the tub and onto articles within the wash chamber of the basket. The basket or an agitation element can rotate at various speeds to agitate articles within the wash chamber, to wring wash fluid from articles within the wash chamber, etc. During a spin or drain cycle, a drain pump assembly may operate to discharge water from within sump.

Conventional washing machine appliances have sensors to accurately monitor and control the conductivity of the wash solution. Conductivity serves as a key indicator of the concentration of dissolved solids, primarily detergents and minerals, which directly impact the washing machine appliance's effectiveness. Sensor assemblies within washing machine appliances have limitations. Notably, sensor rods are traditionally mounted within a conductivity sensor housing after the housing has been molded. This configuration requires a seal, e.g., an o-ring seal, to seal the inner portion of the rods from the liquid being measured. Additionally, contacts and compression springs are utilized to attach sensor rods to a printed circuit board (PCB) assembly. This configuration requires the PCB assembly to be aligned with the sensor rods ends and then inserted into the sensor assembly.

Accordingly, a washing machine appliance with an improved sensor assembly is desirable. More specifically, improved systems and methods to reduce parts and labor in the manufacturing of sensor assemblies within washing machine appliances while maintaining a seal would be particularly beneficial.

### BRIEF DESCRIPTION OF THE INVENTION

Advantages of the invention will be set forth in part in the following description, or may be apparent from the description, or may be learned through practice of the invention.

In one exemplary embodiment, a washing machine appliance is provided. The washing machine appliance, defining a mutually orthogonal vertical direction, lateral direction, and transverse direction, the washing machine appliance including a wash tub positioned within a cabinet, a wash basket rotatably mounted within the wash tub and defining a wash chamber, a dispensing assembly for selectively adding wash fluid to the wash tub, the wash fluid comprising at least one of water or a wash additive, a sump positioned proximate a bottom of the wash tub for collecting the wash fluid, and a sensor assembly positioned within the cabinet, the sensor assembly including a sensor comprising a plurality of sensor rods, wherein an exterior end of each of the plurality of sensor rods and an interior end of each of the plurality of sensor rods comprises a keyed feature, and a sensor housing overmolded onto the sensor aligned by the keyed feature, wherein the exterior end of each of the plurality of sensor rods is oriented exterior to the sensor housing and the interior end of each of the plurality of sensor rods is oriented interior to the sensor housing.

In another exemplary embodiment, a method for assembling a washing machine appliance is provided. The washing machine appliance includes a wash tub positioned within a cabinet, a dispensing assembly for selectively adding wash fluid to the wash tub, a sensor assembly positioned within the cabinet, the sensor assembly comprising a sensor comprising a plurality of sensor rods, a sensor housing, a printed circuit board, and a plurality of printed circuit board mounted spring contacts. The method includes placing the plurality of sensor rods in a mold, injecting moldable material around the plurality of sensor rods to create the sensor housing, forming a seal between an exterior end of each of the plurality of sensor rods and an interior end of each of the plurality of sensor rods, inserting the printed circuit board into the sensor housing, and contacting a plurality of printed circuit board mounted spring contacts to the interior end of each of the plurality of sensor rods.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an example embodiment of the present subject matter with a door of the exemplary washing machine appliance shown in a closed position.

FIG. 2 provides a perspective view of the example washing machine appliance of FIG. 1 with the door of the example washing machine appliance shown in an open position.

FIG. 3 provides a side cross-sectional view of the example washing machine appliance of FIG. 1.

FIG. 4 provides a top view of a dispenser drawer of the example washing machine appliance of FIG. 1 according to an example embodiment of the present subject matter.

FIG. 5 provides a side cross-sectional view of a sensor assembly according to an example embodiment of the present subject matter.

FIG. 6 provides an angled cross-sectional view of the example sensor assembly of FIG. 5 with the turbidity sensor removed.

FIG. 7 provides a perspective view of the example sensor assembly of FIG. 5.

FIG. 8 provides a front perspective view of a portion of the example sensor assembly of FIG. 5.

FIG. 9 illustrates a method for assembling a washing machine appliance in accordance with one embodiment of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

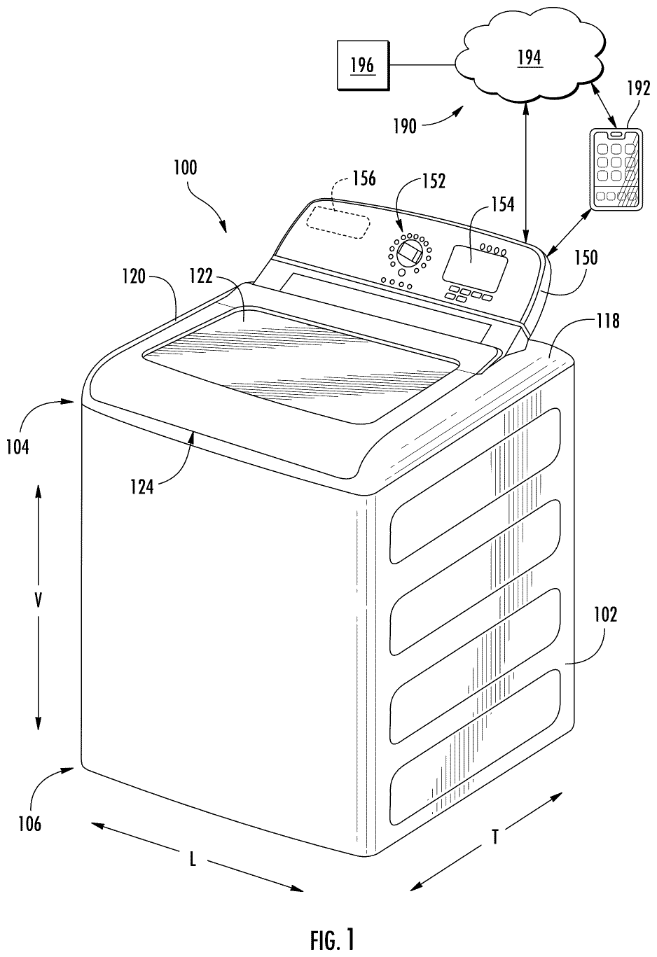

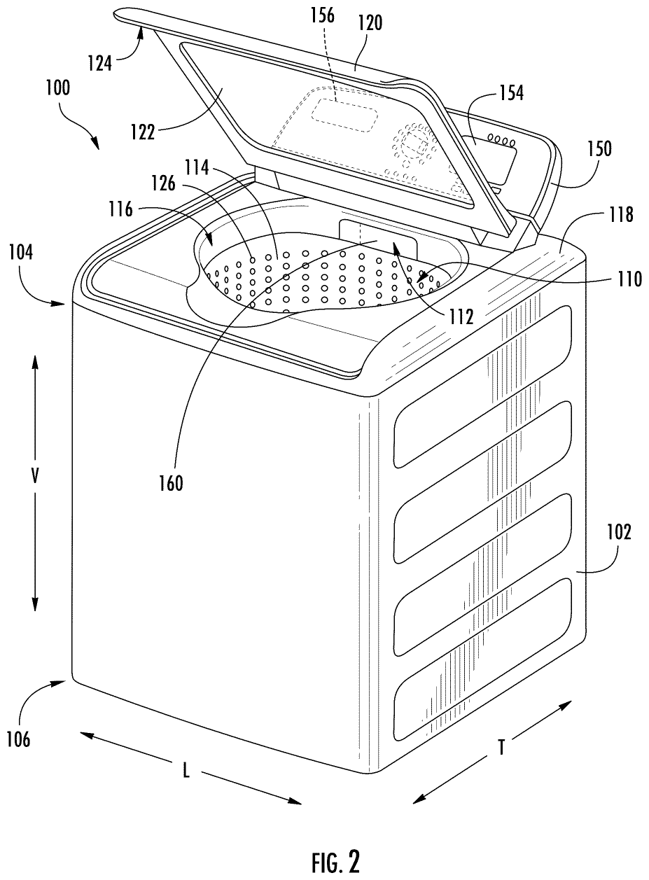

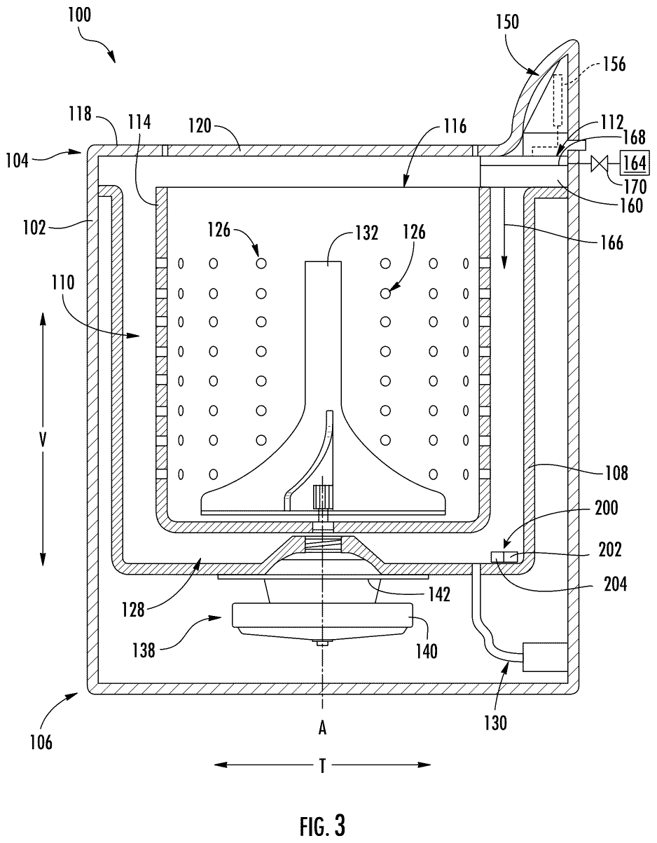

FIGS. 1 through 3 illustrate an exemplary embodiment of a vertical axis washing machine appliance 100. Specifically, FIGS. 1 and 2 illustrate perspective views of washing machine appliance 100 in a closed and an open position, respectively. FIG. 3 provides a side cross-sectional view of washing machine appliance 100. Washing machine appliance 100 generally defines a vertical direction V, a lateral direction L, and a transverse direction T, each of which is mutually perpendicular, such that an orthogonal coordinate system is generally defined.

While described in the context of a specific embodiment of vertical axis washing machine appliance 100, it should be appreciated that vertical axis washing machine appliance 100 is provided by way of example only. It will be understood that aspects of the present subject matter may be used in any other suitable washing machine appliance, such as a horizontal axis washing machine appliance. Indeed, modifications and variations may be made to washing machine appliance 100, including different configurations, different appearances, and/or different features while remaining within the scope of the present subject matter.

Washing machine appliance 100 has a cabinet 102 that extends between a top portion 104 and a bottom portion 106 along the vertical direction V, between a first side (left) and a second side (right) along the lateral direction L, and between a front and a rear along the transverse direction T. As best shown in FIG. 3, a wash tub 108 is positioned within cabinet 102, defines a wash chamber 110, and is generally configured for retaining wash fluids during an operating cycle. Washing machine appliance 100 further includes a primary dispenser or dispensing assembly 112 (FIG. 2) for dispensing wash fluid into wash tub 108.

In addition, washing machine appliance 100 includes a wash basket 114 that is positioned within wash tub 108 and generally defines an opening 116 for receipt of articles for washing. More specifically, wash basket 114 is rotatably mounted within wash tub 108 such that it is rotatable about an axis of rotation A. According to the illustrated embodiment, the axis of rotation A is substantially parallel to the vertical direction V. In this regard, washing machine appliance 100 is generally referred to as a “vertical axis” or “top load” washing machine appliance 100. However, it should be appreciated that aspects of the present subject matter may be used within the context of a horizontal axis or front load washing machine appliance as well.

As illustrated, cabinet 102 of washing machine appliance 100 has a top panel 118. Top panel 118 defines an opening (FIG. 2) that coincides with opening 116 of wash basket 114 to permit a user access to wash basket 114. Washing machine appliance 100 further includes a door 120 which is rotatably mounted to top panel 118 to permit selective access to opening 116. In particular, door 120 selectively rotates between the closed position (as shown in FIGS. 1 and 3) and the open position (as shown in FIG. 2). In the closed position, door 120 inhibits access to wash basket 114. Conversely, in the open position, a user can access wash basket 114. A window 122 in door 120 permits viewing of wash basket 114 when door 120 is in the closed position, e.g., during operation of washing machine appliance 100. Door 120 also includes a handle 124 that, e.g., a user may pull and/or lift when opening and closing door 120. Further, although door 120 is illustrated as mounted to top panel 118, door 120 may alternatively be mounted to cabinet 102 or any other suitable support.

As best shown in FIGS. 2 and 3, wash basket 114 further defines a plurality of perforations 126 to facilitate fluid communication between an interior of wash basket 114 and wash tub 108. In this regard, wash basket 114 is spaced apart from wash tub 108 to define a space for wash fluid to escape wash chamber 110. During a spin cycle, wash fluid within articles of clothing and within wash chamber 110 is urged through perforations 126 wherein it may collect in a sump 128 defined by wash tub 108. Washing machine appliance 100 further includes a pump assembly 130 (FIG. 3) that is located beneath wash tub 108 and wash basket 114 for gravity assisted flow when draining wash tub 108.

An impeller or agitation element 132 (FIG. 3), such as a vane agitator, impeller, auger, oscillatory basket mechanism, or some combination thereof is disposed in wash basket 114 to impart an oscillatory motion to articles and liquid in wash basket 114. More specifically, agitation element 132 extends into wash basket 114 and assists agitation of articles disposed within wash basket 114 during operation of washing machine appliance 100, e.g., to facilitate improved cleaning. In different embodiments, agitation element 132 includes a single action element (i.e., oscillatory only), a double action element (oscillatory movement at one end, single direction rotation at the other end) or a triple action element (oscillatory movement plus single direction rotation at one end, single direction rotation at the other end). As illustrated in FIG. 3, agitation element 132 and wash basket 114 are oriented to rotate about axis of rotation A (which is substantially parallel to vertical direction V).

As best illustrated in FIG. 3, washing machine appliance 100 includes a drive assembly or motor assembly 138 in mechanical communication with wash basket 114 to selectively rotate wash basket 114 (e.g., during an agitation or a rinse cycle of washing machine appliance 100). In addition, motor assembly 138 may also be in mechanical communication with agitation element 132. In this manner, motor assembly 138 may be configured for selectively rotating or oscillating wash basket 114 and/or agitation element 132 during various operating cycles of washing machine appliance 100.

More specifically, motor assembly 138 may generally include one or more of a drive motor 140 and a transmission assembly 142, e.g., such as a clutch assembly, for engaging and disengaging wash basket 114 and/or agitation element 132. According to the illustrated embodiment, drive motor 140 is a brushless DC electric motor, e.g., a pancake motor. However, according to alternative embodiments, drive motor 140 may be any other suitable type or configuration of motor. For example, drive motor 140 may be an AC motor, an induction motor, a permanent magnet synchronous motor, or any other suitable type of motor. In addition, motor assembly 138 may include any other suitable number, types, and configurations of support bearings or drive mechanisms.

Referring still to FIGS. 1 through 3, a control panel 150 with at least one input selector 152 (FIG. 1) extends from top panel 118. Control panel 150 and input selector 152 collectively form a user interface input for operator selection of machine cycles and features. A display 154 of control panel 150 indicates selected features, operation mode, a countdown timer, and/or other items of interest to appliance users regarding operation.

Operation of washing machine appliance 100 is controlled by a controller or processing device 156 that is operatively coupled to control panel 150 for user manipulation to select washing machine cycles and features. In response to user manipulation of control panel 150, controller 156 operates the various components of washing machine appliance 100 to execute selected machine cycles and features. According to an exemplary embodiment, controller 156 may include a memory and microprocessor, such as a general or special purpose microprocessor operable to execute programming instructions or micro-control code associated with methods described herein. Alternatively, controller 156 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 150 and other components of washing machine appliance 100 may be in communication with controller 156 via one or more signal lines or shared communication busses.

During operation of washing machine appliance 100, laundry items are loaded into wash basket 114 through opening 116, and washing operation is initiated through operator manipulation of input selectors 152. Wash basket 114 is filled with water and detergent and/or other fluid additives via primary dispenser 112. One or more valves can be controlled by washing machine appliance 100 to provide for filling wash tub 108 and wash basket 114 to the appropriate level for the amount of articles being washed and/or rinsed. By way of example for a wash mode, once wash basket 114 is properly filled with fluid, the contents of wash basket 114 can be agitated (e.g., with agitation element 132 as discussed previously) for washing of laundry items in wash basket 114.

After completion of the agitation cycle, washing machine appliance 100 may perform one or more rinse cycles. Specifically, according to an example embodiment, drain pump assembly 130 may drain the wash fluid from wash tub 108 and dispensing assembly 112 may dispense fresh water and/or a wash additive (such as fabric softener) into the wash tub. The load of clothes may then be agitated in the fresh water, e.g., to remove soil and detergent from load of clothes. After completion of the rinse cycle(s), drain pump assembly 130 may drain wash tub 108 and a spin cycle may be used to extract water from the clothes before the wash cycle is concluded.

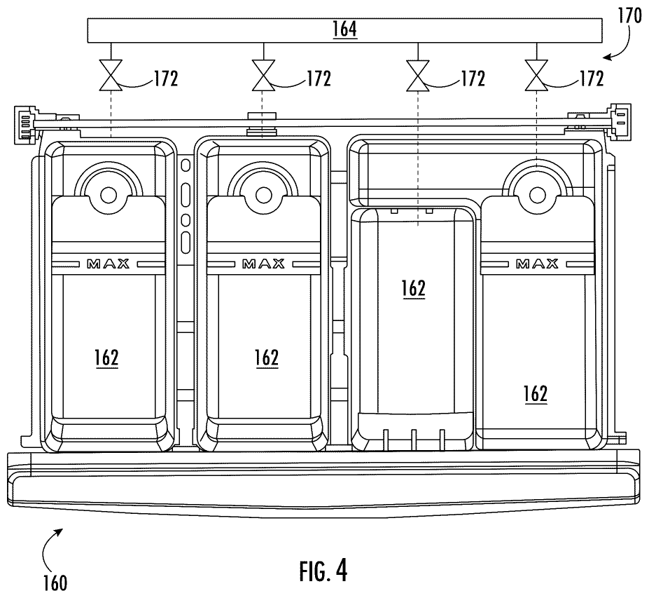

Referring now specifically to FIGS. 2 through 4, dispensing assembly 112 of washing machine appliance 100 will be described in more detail. As explained briefly above, dispensing assembly 112 may generally be configured to dispense wash fluid to facilitate one or more operating cycles or phases of an operating cycle (e.g., such as a wash cycle or a rinse cycle). The terms “wash fluid” and the like may be used herein to generally refer to a liquid used for washing and/or rinsing clothing or other articles. For example, the wash fluid is typically made up of water that may include other additives such as detergent, fabric softener, bleach, or other suitable treatments (including combinations thereof). More specifically, the wash fluid for a wash cycle may be a mixture of water, detergent, and/or other additives, while the wash fluid for a rinse cycle may be water only and/or additional rinse additives.

As illustrated, dispensing assembly 112 may generally include a dispenser drawer 160 that is slidably mounted within cabinet 102 for receiving one or more wash additives or detergents. In this regard, a user may slide detergent drawer 160 out from cabinet 102 for supplying wash additives needed for a wash cycle. In this regard, detergent drawer 160 may define one or more detergent chambers (e.g., identified herein generally by reference numeral 162). Detergent chambers 162 may be generally configured for storing one or more wash additives for use during a washing cycle. For example, according to the illustrated embodiment, detergent drawer 160 defines a pre-wash chamber, a fabric softener chamber, a main wash chamber, and a detergent pod chamber. It should be appreciated that according to alternative embodiments, detergent drawer 160 may define other chambers for receiving other wash additives (e.g., such as bleach or other additives) while remaining within the scope of the present subject matter.

After additives have been supplied into detergent drawer 160, the user may slide detergent drawer 160 back into dispensing assembly 112 where a water supply 164 may selectively dispense fresh water to flush out one or more compartments of detergent drawer 160 and to create the flow of wash fluid 166 (FIG. 3). According to an example embodiment, a shower plate 168 may generally be positioned over detergent drawer 160 when detergent drawer 160 is inserted into dispensing assembly 112. According to an example embodiment, shower plate 168 may define a plurality of reservoirs that correspond to detergent chambers 162 and includes a plurality of water supply apertures (not shown) or perforations for discharging the freshwater from water supply 164 down into one or more detergent chambers 162. In this manner, fresh water and/or additives may be showered or flooded within dispenser drawer 160 where they may be mixed prior to passing into wash tub 108 (e.g., as flow of wash fluid 166).

As shown schematically in FIG. 3, dispensing assembly 112 may further include a valve assembly 170 including a plurality of freshwater supply valves 172 positioned at a rear of shower plate 168 for providing flows of hot and/or cold water into shower plate 168, e.g., from water supply 164. Controller 156 may selectively operate supply valves 172 to dispense water from water supply 164 into one or more reservoirs of shower plate 168. The flow of water may pass through shower plate 168 into one or more detergent chambers 162 to flush the detergent into wash tub 108 as the flow of wash fluid 166 at a desired time of the wash cycle and at a desired fluid temperature.

After wash tub 108 is filled and the agitation phase of the wash cycle is completed, wash basket 114 can be drained, e.g., by drain pump assembly 130. Laundry articles can then be rinsed by again adding fluid to wash basket 114 depending on the specifics of the cleaning cycle selected by a user. The impeller or agitation element 132 may again provide agitation within wash basket 114. One or more spin cycles may also be used as part of the cleaning process. In particular, a spin cycle may be applied after the wash cycle and/or after the rinse cycle in order to wring wash fluid from the articles being washed. During a spin cycle, wash basket 114 is rotated at relatively high speeds to help wring fluid from the laundry articles through perforations 126. During or prior to the spin cycle, drain pump assembly 130 may operate to discharge wash fluid from wash tub 108, e.g., to an external drain. After articles disposed in wash basket 114 are cleaned and/or washed, the user can remove the articles from wash basket 114, e.g., by reaching into wash basket 114 through opening 116.

Referring still to FIG. 1, a schematic diagram of an external communication system 190 will be described according to an exemplary embodiment of the present subject matter. In general, external communication system 190 is configured for permitting interaction, data transfer, and other communications between washing machine appliance 100 and one or more external devices. For example, this communication may be used to provide and receive operating parameters, user instructions or notifications, performance characteristics, user preferences, or any other suitable information for improved performance of washing machine appliance 100. In addition, it should be appreciated that external communication system 190 may be used to transfer data or other information to improve performance of one or more external devices or appliances and/or improve user interaction with such devices.

For example, external communication system 190 permits controller 156 of washing machine appliance 100 to communicate with a separate device external to washing machine appliance 100, referred to generally herein as an external device 192. As described in more detail below, these communications may be facilitated using a wired or wireless connection, such as via a network 194. In general, external device 192 may be any suitable device separate from washing machine appliance 100 that is configured to provide and/or receive communications, information, data, or commands from a user. In this regard, external device 192 may be, for example, a personal phone, a smartphone, a tablet, a laptop or personal computer, a wearable device, a smart home system, or another mobile or remote device.

In addition, a remote server 196 may be in communication with washing machine appliance 100 and/or external device 192 through network 194. In this regard, for example, remote server 196 may be a cloud-based server 196, and is thus located at a distant location, such as in a separate state, country, etc. According to an exemplary embodiment, external device 192 may communicate with a remote server 196 over network 194, such as the Internet, to transmit/receive data or information, provide user inputs, receive user notifications or instructions, interact with or control washing machine appliance 100, etc. In addition, external device 192 and remote server 196 may communicate with washing machine appliance 100 to communicate similar information.

In general, communication between washing machine appliance 100, external device 192, remote server 196, and/or other user devices or appliances may be carried using any type of wired or wireless connection and using any suitable type of communication network, non-limiting examples of which are provided below. For example, external device 192 may be in direct or indirect communication with washing machine appliance 100 through any suitable wired or wireless communication connections or interfaces, such as network 194. For example, network 194 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 190 is described herein according to an exemplary embodiment of the present subject matter. However, it should be appreciated that the exemplary functions and configurations of external communication system 190 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

While described in the context of a specific embodiment of vertical axis washing machine appliance 100, using the teachings disclosed herein it will be understood that vertical axis washing machine appliance 100 is provided by way of example only. Other washing machine appliances having different configurations, different appearances, and/or different features may also be utilized with the present subject matter as well, e.g., horizontal axis washing machine appliances. In addition, aspects of the present subject matter may be utilized in a combination washer/dryer appliance.

Referring now specifically to FIG. 3, washing machine appliance 100 may include a sensor assembly 200 that includes one or more sensors for providing useful information regarding a particular load or operating cycle of the appliance. This information may be used for improved appliance performance, as described in more detail herein. For example, sensor assembly 200 may include a turbidity sensor 202, e.g., for monitoring the contaminant level or soil level of wash fluid 166, e.g., in order to determine the cleanliness of the clothes, to determine appropriate rinse parameters, or to identify wash additives added to the flow of wash fluid 166.

According to an example embodiment, turbidity sensor 202 may operate by using an emitter to emit a beam of light that is passed through wash fluid 166 and detecting the beam of light using a receiver. In this manner, the turbidity of wash fluid 166 may be estimated based on the distortion of the beam of light. Although turbidity sensor 202 is illustrated herein as including an emitter and receiver for generating and receiving a beam of light, it should be appreciated that this is only one exemplary embodiment. Any other suitable type or configuration of turbidity sensor may be used while remaining within the scope of the present subject matter. Other sensor configurations are possible and within the scope of the present subject matter.

In addition, sensor assembly 200 may be used to monitor the wash process using any other suitable sensors. For example, as illustrated, sensor assembly 200 may include a conductivity sensor 204 that is positioned in sump 128 and is configured for monitoring conductivity or other suitable parameters or conditions of the wash fluid 166. For example, conductivity sensor 204 may measure the electrical conductivity of the wash fluid 166. In addition, or alternatively, sensor assembly 200 may include other sensors, e.g., such as a pH sensor for measuring the pH of the wash fluid 166.

According to the illustrated embodiment, sensor assembly 200 may be mounted within sump 128 where it is capable of obtaining accurate reading of wash fluid 166 within wash tub 108. According to still other embodiments, sensor assembly 200 may alternatively be positioned within a drain line or in drain pump assembly 130, within a recirculation line or assembly, or at any other location where it is in contact with collected wash fluid 166. According to an example embodiment, conductivity sensor 204 and turbidity sensor 202 are embodied in a single sensor unit positioned within sump 128 of wash tub 108.

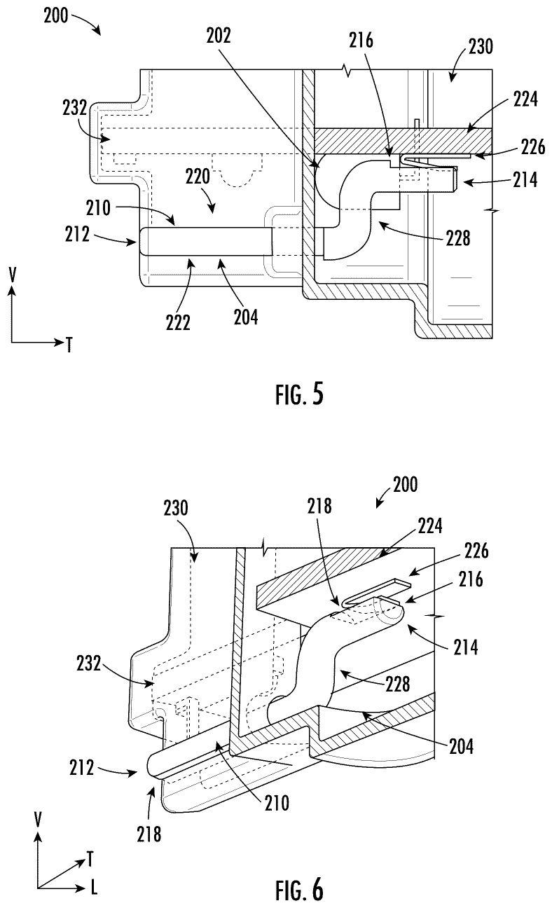

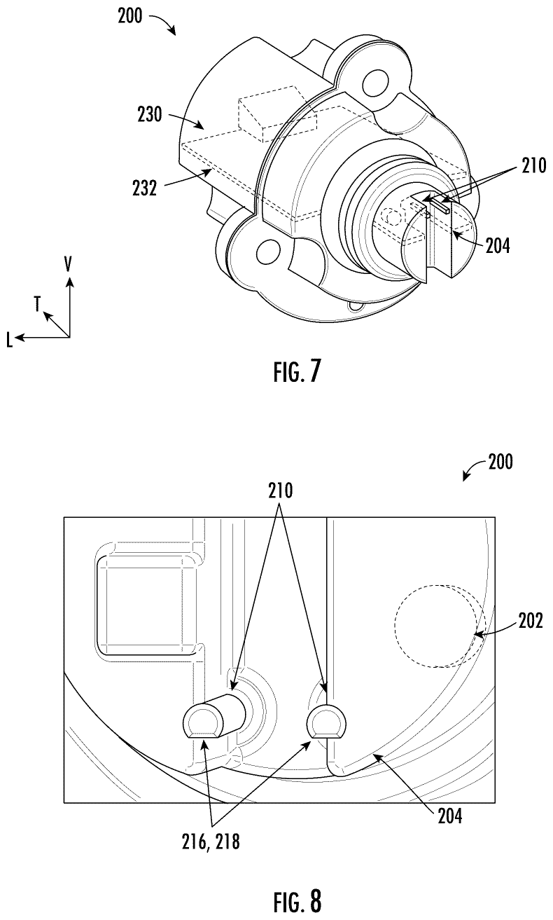

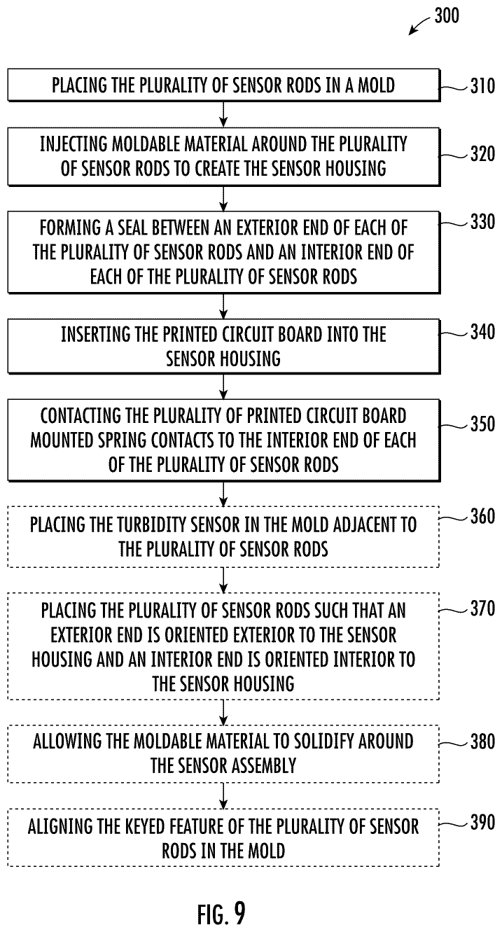

FIGS. 5 through 8 illustrate an example embodiment of the sensor assembly 200. In one example embodiment, the sensor assembly 200 may include a sensor. This sensor may include a conductivity sensor 204, turbidity sensor 202, and a temperature sensor, or any combination thereof. The example sensor may include a plurality of sensor rods 210, where one rod may be a cathode rod and another rod may be an anode rod. Further, the plurality of sensor rods may include an exterior end 212 as well as an interior end 214. Both the interior end 212 and exterior end 214 of the plurality of sensor rods 210 may include a keyed feature 216. This keyed feature 216 is a uniquely shaped feature that allows for correct orientation of the plurality of sensor rods 210 within a mold to be used for forming a sensor housing 230. The sensor housing 230 may be formed by being overmolded onto the sensor onto the sensor aligned by the keyed feature 216, wherein the exterior end 212 of each of the plurality of sensor rods 210 is oriented exterior to the sensor housing 230, as to the exterior end 212 of each of the plurality of sensor rods 210 to come into contact with the wash fluid 166. Further, the interior end 214 of each of the plurality of sensor rods 210 is oriented interior to the sensor housing 230.

The process of overmolding the sensor housing 230 onto the sensor rods allows for the formation of a seal without the use of mechanical fasteners, e.g., o-rings. However, in alternative embodiments, the use of mechanical fasteners, adhesives, or press-fit arrangements may be used to supplement and reinforce the seal. Overmolding involves ensuring the plurality of sensor rods 210 are constructed to specified tolerances, where the keyed feature 216 is incorporated into each of the exterior ends 212 and interior ends 214 of the plurality of sensor rods'210 geometry for orientation. A specialized fixture may be employed to hold the plurality of sensor rods 210 in their prescribed orientations during the overmolding process. The fixture may include alignment pins that mate with the keyed feature 216 on the plurality of sensor rods 210 to ensure proper angular orientation.

The overmolding process may include distinct stages. The first stage may include a first-shot molding operation that creates the primary housing structure of the sensor housing 320 around the plurality of sensor rods 210 as well as other potential inclusions (e.g., a printed circuit board 230, etc.). This first-shot molding operation may involve using a material that possesses sufficient rigidity to maintain the position of the plurality of sensor rods 210, compatible surface chemistry for a potential second-shot material, and appropriate thermal properties to prevent sensor rod distortion. This material may include Glass-filled Polybutylene Terephthalate (PBT), Polycarbonate (PC), Acrylonitrile Butadiene Styrene (ABS), Glass-filled Nylon (PA66), Polyetherimide (PEI), or any other suitable material that meets the above listed criteria.

The overmolding process may involve a second stage, which may involve the primary housing structure, or first-shot assembly, being placed within a second mold cavity while maintaining the orientation of the plurality of sensor rods 210 within the potentially partially completed sensor housing 230. The second-shot molding operation involves material, that may or may not be the same as the first-shot modling operation material, being injected at a controlled temperature and pressure to flow around the plurality of sensor rods 210 to create environmental seals at all desired interfaces around the plurality of plurality of sensor rods 210. Further, the second-shot molding material may bond chemically with the first-shot material. The second-shot molding material may be Thermoplastics Elastomers (TPE) such as Sustrenic Block Copolymers (TPE-S), Vulcanizate (TPE-V), Polyurethane (TPE-U), Copolyester (TPE-E), and Olefinic (TPE-O). Additionally or alternatively, the second-shot molding material may be Themorplastic Vulcanizates (TPV) such as EPDM/PP based materials and Santoprene. Additionally or alternatively, the second-shot molding material may include any other suitable material that is appropriate to create an environmental seal.

In an alternative embodiment, the overmolding may be completed in one robust stage by implementing aspects of the first and second stage, primarily orienting the plurality of sensor rods 210 using the keyed features 216, placing the plurality of sensor rods 210 within a mold, pouring a suitable material around the plurality of sensor rods 210 at a controlled temperature and pressure, and creating an environmental seal around the plurality of sensor rods 210.

In one example embodiment, the keyed feature 216 of the plurality of sensor rods 210 may be characterized by a partial cylindrical profile with a flattened position, as illustrated in FIGS. 5 through 8. This keyed feature 216 may approximately resemble the shape of the letter “D.” This flattened portion may distally extend along the transverse direction of each of the interior end 214 and exterior end 212 of the plurality of sensor rods 210. The flattened position may extend along the transverse direction half-way up the vertical direction of the plurality of sensor rods 210 creating a partial cylindrical profile that is semi-circle shaped. Alternatively, the flattened position may extend along the transverse direction at any point along the vertical direction of the plurality of sensor rods 210 creating a partial cylindrical profile. In another example embodiment, the flattened portion of the exterior end 212 of each of the plurality of sensor rods 210 may be disposed on a bottom of the exterior end 212 of the plurality of sensor rods 210. Further, the flattened portion of the interior end 214 of each of the plurality of sensor rods 210 may be disposed on a top of the interior end 214 of the plurality of sensor rods 210. In another example embodiment, the keyed feature may be any unique recess, shape, or design existing on each of the exterior ends 212 and interior ends 214 of the plurality of sensor rods 210.

The sensor assembly 200 may further include a printed circuit board 224 positioned within the sensor housing 230. Further, a plurality of printed circuit board mounted spring contacts 226 configured to receive the interior end 214 of each of the plurality of sensor rods 210 may be included in the sensor assembly 200. Each of the plurality of printed circuit board mounted spring contacts 226 may come into contact with a bottom of the printed circuit board 224 as well as a top of the keyed feature 216 of the interior end 214 of the plurality of sensor rods 210. In one example embodiment, the plurality of printed circuit board mounted spring contacts 226 are soldered onto the printed circuit board 224. In another example embodiment, the plurality of printed circuit board mounted spring contacts 226 are leaf springs. In another example embodiment, the plurality of printed circuit board mounted spring contacts 226 are bridge contacts with the printed circuit board 224 and the interior end 214 of the plurality of sensor rods 210, without the presence of a compression spring on a gold-plated surface.

The overmolding process may account for the inclusion of the printed circuit board 224 by including a printed circuit board guide 232 within the sensor housing 230. The printed circuit board guide 232 orients the printed circuit board 224 at a pre-determined position. In one example embodiment, the printed circuit board guide 232 will extend along the transverse direction and be located above the plurality of sensor rods 210 about the vertical direction.

As illustrated in FIGS. 5 and 6, in one example embodiment, the plurality of sensor rods 210 include a curvature 228 between the exterior end 212 of each of the plurality of sensor rods 210 and the interior end 214 of each of the plurality of sensor rods 210. This curvature allows for the interior end 214 and the exterior end 212 to be disposed at different positions along the vertical axis. As illustrated, this curvature 228 may be approximately 90 degrees. In another example embodiment, the curvature 228 may range from 5 degrees to 175 degrees, depending on the shape of the sensor housing 230, the desired location of the sensor assembly 200 within the washing machine appliance 100, and the desired orientation of each of the interior end 214 and exterior end 212 of the plurality of sensor rods 210 within the sensor housing 230. Alternatively, the sensor rod may be generally straight without the presence of the curvature 228.

Referring specifically to FIG. 5, in one example embodiment, the sensor assembly 200 may include a turbidity sensor 202 located adjacent to the curvature 228 between the exterior end 212 of each of the plurality of sensor rods 210 and the interior end 214 of each of the plurality of sensor rods 210. The turbidity sensor 202 would be located below the printed circuit board 224 about the vertical direction. Further, the turbidity sensor 202 may be attached to the printed circuit board 224.

Referring now to FIG. 9, now that the construction of washing machine appliance 100 and the sensor assembly 200 according to example embodiments have been presented, an exemplary method 300 of assembling a washing machine appliance will be described. Although the discussion below refers to the exemplary method 300 of assembling washing machine appliance 100, one skilled in the art will appreciate that the exemplary method 300 is applicable to the assembly of a variety of other washing machine appliances, such as horizontal axis washing machine appliances. In example embodiments, the various method steps as disclosed herein may be performed by any capable agent, which include but are not limited to a machine, an artificial intelligence powered machine, an artificial intelligence agent directed device, or a user operator.

Specifically, method 300 includes, at step 310, placing the plurality of sensor rods in a mold. In this regard, continuing the example from above, the washing machine appliance 100 would be assembled, in part, by a capable agent initiating the placement of the plurality of sensor rods 210 in a mold. According to example embodiments, the mold may be in the shape of the sensor housing 230, in whole or in part, which is a part of the sensor assembly 200. The mold may actually be a plurality of molds, distinct from each other, where each of the plurality of molds is designed to capture the distinct molding stages as discussed above. The placement of the plurality of sensor rods in a mold may take place during the assembly of the washing machine appliance 100. Accordingly, this may happen in parallel to other manufacturing steps associated with the washing machine appliance 100 or may happen separately from other manufacturing steps associated with the washing machine appliance 100. Alternatively, this may happen during a specified phase of the manufacturing process of the washing machine appliance 100.

Method 300 further includes, at step 320, injecting moldable material around the plurality of sensor rods to create the sensor housing. In example embodiments, the moldable material may be any of suitable material, including but not limited to, the examples listed above to create the sensor housing 230 of the sensor assembly 200. Further, the moldable material may consist of a plurality of materials. The plurality of materials may be introduced into the mold together or at separate times.

Method 300 further includes, at step 330, forming a seal between an exterior end of each of the plurality of sensor rods and an interior end of each of the plurality of sensor rods. In example embodiments, the exterior end 212 of the plurality of sensor rods 210 may be positioned exterior to the sensor housing 230, while the interior end 214 of each of the plurality of sensor rods 210 may be positioned interior to the sensor housing 230. The seal may be formed as a part of a single molding stage or may involve distinct stages as mentioned above.

Method 300 further includes, at step 340, inserting the printed circuit board into the sensor housing. In example embodiments, this may involve the use of the printed circuit board guide 232 to orient the positioning of the printed circuit board 232 within the sensor housing 230.

Method 300 further includes, at step 350, contacting the plurality of printed circuit board mounted spring contacts to the interior end of each of the plurality of sensor rods. In example embodiments, this may involve the printed circuit board guide 232, and thus the printed circuit board 224, to be oriented above the top 220 of the plurality of sensor rods 210 within the sensor housing 230 of the sensor assembly 200 as mentioned above.

Method 300 may further include, at step 360, placing the turbidity sensor in the mold adjacent to the plurality of sensor rods. In example embodiments, the sensor assembly 200 would comprise a turbidity sensor 202 as well as a conductivity sensor 204. This may involve orienting the turbidity sensor 202 in a position that is below the printed circuit board 224 in order to attach it to the printed circuit board 224 within the sensor housing 230 of the sensor assembly 200 as mentioned above.

Method 300 may further include, at step 370, positioning the plurality of sensor rods such that an exterior end of each of the plurality of sensor rods is oriented exterior to the sensor housing and an interior end of each of the plurality of sensor rods is oriented interior to the sensor housing. In example embodiments, the exterior end 212 of the plurality of sensor rods 212 is positioned exterior to the sensor housing 230 so it may come into contact with the wash fluid 166. Further, the interior end 214 of each of the plurality of sensor rods 210 is oriented to come into contact with the printed circuit board mounted spring contacts 226 and, by proxy, the printed circuit board 224.

Method 300 may further include, at step 380, allowing the moldable material to solidify around the sensor assembly. In example embodiments, the sensor housing 230 is formed by allowing the moldable material to solidify. As mentioned above, this may be done in distinct phases or one single phase.

Method 300 may further include, at step 390, aligning the keyed feature of the plurality of sensor rods in the mold. In example embodiments, an exterior end 212 of each of the plurality of sensor rods 210 and an interior end 214 of each of the plurality of sensor rods 210 comprises a keyed feature 216, as discussed above. This keyed feature would allow for alignment of the sensor rods 210 when being placed in the mold. In such an embodiment, the keyed feature 216 may help with the placement of the plurality of sensor rods 210 in the mold, as mentioned in step 310. In one example embodiment, the keyed feature 216 may be characterized by a partial cylindrical profile with a flattened position, as discussed above.

Method 300 may further include positioning the plurality of sensor rods such that the flattened portion of the exterior end of each of the plurality of sensor rods is disposed on a bottom of the exterior end of the plurality of sensor rods. In example embodiments, the keyed feature 216 may be characterized by a partial cylindrical profile with a flattened position, as discussed above.

Method 300 may further include positioning the plurality of sensor rods such that the flattened portion of the interior end of each of the plurality of sensor rods is disposed on a top of the interior end of the plurality of sensor rods. In example embodiments, the keyed feature 216 may be characterized by a partial cylindrical profile with a flattened position, as discussed above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance, defining a mutually orthogonal vertical direction, lateral direction, and transverse direction, the washing machine appliance comprising:
a wash tub positioned within a cabinet;
a wash basket rotatably mounted within the wash tub and defining a wash chamber;
a dispensing assembly for selectively adding wash fluid to the wash tub, the wash fluid comprising at least one of water or a wash additive;
a sump positioned proximate a bottom of the wash tub for collecting the wash fluid; and
a sensor assembly positioned within the cabinet, the sensor assembly comprising:
a sensor comprising a plurality of sensor rods, wherein an exterior end of each of the plurality of sensor rods and an interior end of each of the plurality of sensor rods comprises a keyed feature; and
a sensor housing overmolded onto the sensor aligned by the keyed feature, wherein the exterior end of each of the plurality of sensor rods is oriented exterior to the sensor housing and the interior end of each of the plurality of sensor rods is oriented interior to the sensor housing.

2. The washing machine appliance of claim 1, wherein the keyed feature is characterized by a partial cylindrical profile with a flattened portion.

3. The washing machine appliance of claim 2, wherein the flattened portion of the exterior end of each of the plurality of sensor rods is disposed on a bottom of the exterior end of the plurality of sensor rods.

4. The washing machine appliance of claim 2, wherein the flattened portion of the interior end of each of the plurality of sensor rods is disposed on a top of the interior end of the plurality of sensor rods.

5. The washing machine appliance of claim 1, the sensor assembly further comprising:
a printed circuit board positioned within the sensor housing; and
a plurality of printed circuit board mounted spring contacts configured to receive the interior end of each of the plurality of sensor rods.

6. The washing machine appliance of claim 5, wherein the plurality of printed circuit board mounted spring contacts are soldered onto the printed circuit board.

7. The washing machine appliance of claim 6, the sensor housing comprising:
a printed circuit board guide, wherein the printed circuit board guide orients the printed circuit board at a pre-determined position.

8. The washing machine appliance of claim 1, wherein the sensor is a conductivity sensor.

9. The washing machine appliance of claim 1, wherein the plurality of sensor rods comprise a curvature between the exterior end of each of the plurality of sensor rods and the interior end of each of the plurality of sensor rods.

10. The washing machine appliance of claim 9, the sensor assembly further comprising:
a turbidity sensor located adjacent to the curvature between the exterior end of each of the plurality of sensor rods and the interior end of each of the plurality of sensor rods.

11. The washing machine appliance of claim 9, wherein the curvature between the exterior end of each of the plurality of sensor rods and the interior end of each of the plurality of sensor rods is approximately 90 degrees.

12. A method for assembling a washing machine appliance, the washing machine appliance comprising a wash tub positioned within a cabinet, a dispensing assembly for selectively adding wash fluid to the wash tub, a sensor assembly positioned within the cabinet, the sensor assembly comprising a sensor comprising a plurality of sensor rods, a sensor housing, a printed circuit board, and a plurality of printed circuit board mounted spring contacts, the method comprising:
placing the plurality of sensor rods in a mold;
injecting moldable material around the plurality of sensor rods to create the sensor housing;
forming a seal between an exterior end of each of the plurality of sensor rods and an interior end of each of the plurality of sensor rods;
inserting the printed circuit board into the sensor housing; and
contacting the plurality of printed circuit board mounted spring contacts to the interior end of each of the plurality of sensor rods.

13. The method of claim 12, wherein the sensor assembly further comprises a turbidity sensor, the method further comprising:
placing the turbidity sensor in the mold adjacent to the plurality of sensor rods.

14. The method of claim 12, the method further comprising:
positioning the plurality of sensor rods such that an exterior end of each of the plurality of sensor rods is oriented exterior to the sensor housing and an interior end of each of the plurality of sensor rods is oriented interior to the sensor housing.

15. The method of claim 12, wherein forming a seal between an exterior end of each of the plurality of sensor rods and an interior end of each of the plurality of sensor rods comprises:
allowing the moldable material to solidify around the sensor assembly.

16. The method of claim 12, wherein an exterior end of each of the plurality of sensor rods and an interior end of each of the plurality of sensor rods comprises a keyed feature.

17. The method of claim 16, wherein placing the plurality of sensor rods in a mold comprises:
aligning the keyed feature of the plurality of sensor rods in the mold.

18. The method of claim 16, wherein the keyed feature is characterized by a partial cylindrical profile with a flattened portion.

19. The method of claim 18, the method further comprising:
positioning the plurality of sensor rods such that the flattened portion of the exterior end of each of the plurality of sensor rods is disposed on a bottom of the exterior end of the plurality of sensor rods.

20. The method of claim 18, the method further comprising:
positioning the plurality of sensor rods such that the flattened portion of the interior end of each of the plurality of sensor rods is disposed on a top of the interior end of the plurality of sensor rods.
